(19) United States
(12) Patent Application Publication
(10) Pub. No.: US 2025/0036099 A1
(43) Pub. Date: Jan. 30, 2025

(54) SELECTION DEVICE, SIMULATION DEVICE, AND COMMUNICATION CONTROL DEVICE

(71) Applicant: FANUC CORPORATION, Minamitsuru-gun, Yamanashi (JP)

(72) Inventors: Junichiro KONO, Yamanashi (JP); Toshihiro WATANABE, Yamanashi (JP)

(21) Appl. No.: 18/695,636

(22) PCT Filed: Oct. 27, 2021
(86) PCT No.: PCT/JP2021/039684

§ 371 Date: Oct. 11, 2024

(51) Int. Cl. G05B 19/19

(52) U.S. Cl. CPC G05B 19/19; G05B 2219/42163

(57) ABSTRACT

The present invention reduces position data to a quantity which can be processed in physical simulation, to thereby stabilize processing time of the physical simulation and prevent a loss of a real-time property. Provided is a selection device for selecting position data indicating a path of a movable part included in an industrial machine when executing physical simulation that treats the movable part as an observation target, the selection device comprising: a holding unit that holds the position data in association with time-series information; a range determination unit that determines a lower limit time and an upper limit time indicating a range for the position data from among the position data held by the holding unit; a number-of-pieces-of-data determination unit that determines the number of pieces of position data to be selected from among the position data in the range in consideration of a processing load of the physical simulation; and a selection unit that selects the set number of pieces of position data from among the position data in the range.

### TECHNICAL FIELD

The present invention relates to a selection device, a simulation device, and a communication control device.

### BACKGROUND ART

There exists a technology for performing physical simulation based on pieces of position data of a movable part (a control axis) of an industrial machine such as a machine tool or a robot, which is to be an observation target, and three-dimensional models of the movable part and other things such as a workpiece.

For example, a technology is known in which addition is made with fixed time that is check time indicating time required for physical simulation, to calculate lead time, a position after the lead time is then calculated as a lead position based on look-ahead block instruction data, and physical simulation is performed based thereon, and if it is judged that the movable part and the other things mutually interfere, the movable part is decelerated and stopped to prevent interference. See, for example, Patent Document 1.

When time required for physical simulation is long, there is a problem that the accuracy of the physical simulation decreases because a physical simulation period increases.

Therefore, as a technology for ensuring the accuracy, a technology is known in which, by selecting a part of pieces of position data that are important for physical simulation and checking only the selected pieces of position data, processing time is reduced, with the accuracy of the simulation being ensured. See, for example, Patent Document 2.

### CITATION LIST

### Patent Document

Patent Document 1: Japanese Patent No. 4221016
Patent Document 2: Japanese Patent No. 5339999

### DISCLOSURE OF THE INVENTION

### Problems to be Solved by the Invention

When a real-time property is required for physical simulation such as interference check during operation of an industrial machine, there may be a case where it is desired to improve accuracy as much as possible, with processing time of the physical simulation being ensured.

In Patent Document 2, though the accuracy is ensured, the processing time of physical simulation may increase because the pieces of position data are not necessarily reduced to a quantity which can be processed in the physical simulation. Therefore, there may be a case where Patent Document 2 cannot be applied to such physical simulation that it is desired to ensure the real-time property.

For example, as shown in FIG. 13, in the case of grooving by a continuous circular motion, machining of a groove larger than a tool diameter becomes possible by a tool such as an end mill moving forward on a workpiece surface along an instruction path drawing a circle shape. However, since the angle difference of a course direction vector is constant, pieces of position data cannot be selected, and all pieces of position data may be outputted.

Therefore, it is desired to reduce pieces of position data to a quantity which can be processed in physical simulation, to thereby stabilize processing time of the physical simulation and prevent loss of a real-time property.

### Means for Solving the Problems

(1) One aspect of a selection device of the present disclosure is a selection device for, when physical simulation is performed with a movable part included in an industrial machine as an observation target, selecting pieces of position data showing a path of the movable part, the selection device including: a holding unit configured to hold the pieces of position data in association with time-series information; a range determination unit configured to determine an earliest time point and a latest time point indicating a range for selecting the pieces of position data from among the pieces of position data held by the holding unit; a number-of-pieces-of-data determination unit configured to set a number of pieces of position data to be selected from among the pieces of position data existing in the range in consideration of a processing load of the physical simulation; and a selection unit configured to select the set number of pieces of position data from among the pieces of position data existing in the range.

(2) One aspect of a simulation device of the present disclosure is a simulation device for executing the physical simulation of an observation target, the simulation device including: the selection device of (1); a simulation unit configured to perform the physical simulation using pieces of position data selected by the selection device; and a processing state acquisition unit configured to acquire information including any of a load of the simulation unit and a completion status of the physical simulation by the simulation unit.

(3) One aspect of a communication control device of the present disclosure is a communication control device communicably connected to the simulation device performing the physical simulation of an observation target, the communication control device including: the selection device of (1); a position data output unit configured to transfer pieces of position data selected by the selection device to the simulation device; and a processing state input unit configured to receive input of information from the simulation device, the information including at least any of a load of hardware of the simulation device, a completion status of the physical simulation at a predetermined time point, and an instruction to output the pieces of position data from the simulation device.

### Effects of the Invention

According to one aspect, it is possible to reduce pieces of position data to a quantity which can be processed in physical simulation, to thereby stabilize processing time of the physical simulation and prevent loss of a real-time property.

### BRIEF DESCRIPTION OF THE DRAWINGS

FIG. 1 is a functional block diagram showing a functional configuration example of an interference check system according to one embodiment;

FIG. 2 is a diagram showing an example of pieces of position data held by a holding unit;

FIG. 3 is a diagram showing an example of a relationship between selection periods and time required for interference check;

FIG. 4 is a diagram showing an example of a tool path;

FIG. 5 is a diagram showing an example of positions on the tool path of FIG. 4, which are outputted to an interference check device by a conventional technology;

FIG. 6 is a diagram showing an example of the tool path;

FIG. 7 is a diagram showing an example of positions on the tool path of FIG. 6, which are outputted to the interference check device by the conventional technology;

FIG. 8 is a diagram showing an example of positions on the tool path of FIG. 6, which are outputted to the interference check device by a conventional technology;

FIG. 9A is a diagram showing an example in a case where the number N is set to “1”;

FIG. 9B is a diagram showing an example in a case where the number N is set to “4”;

FIG. 10 is a flowchart illustrating a selection process of a selection device;

FIG. 11 is a functional block diagram showing a functional configuration example of an interference check system;

FIG. 12 is a functional block diagram showing a functional configuration example of an interference check system; and

FIG. 13 is a diagram showing an example of pieces of position data in a case of grooving by a continuous circular motion.

### PREFERRED MODE FOR CARRYING OUT THE INVENTION

A specific embodiment of a control device will be described by using a numerical control device as an example of the control device. The present invention is not limited to a numerical control device but is applicable to a robot control device for controlling, for example, an industrial robot. Further, the present invention is also applicable to a control device for controlling any industrial machine. Here, as the industrial machine, various machines, for example, a machine tool, an industrial robot, a service robot, a forging machine, and an injection molding machine are included.

### One Embodiment

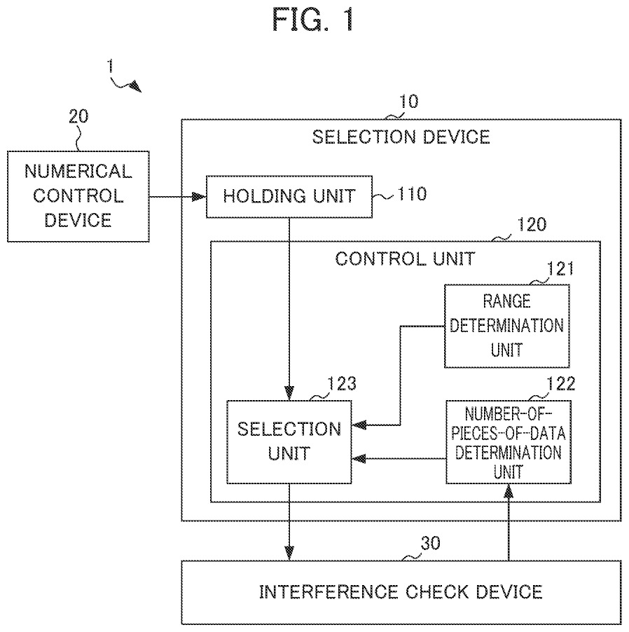

FIG. 1 is a functional block diagram showing a functional configuration example of an interference check system according to one embodiment.

As shown in FIG. 1, an interference check system 1 includes a selection device 10, a numerical control device 20, and an interference check device 30.

The selection device 10, the numerical control device 20, and the interference check device 30 may be mutually directly connected via connection interfaces not shown. The selection device 10, the numerical control device 20, and the interference check device 30 may be mutually connected via a network not shown, such as a LAN (local area network) or the Internet. In this case, the selection device 10, the numerical control device 20, and the interference check device 30 are provided with communication units not shown, respectively, for performing mutual communication via such connection.

### <Numerical Control Device 20>

The numerical control device 20 is a numerical control device that is well known to one skilled in the art. For example, the numerical control device 20 generates an operation instruction based on a machining program acquired from a CAD/CAM device or the like not shown, and transmits the generated operation instruction to a machine tool (not shown). Thereby, the numerical control device 20 controls operation of the machine tool not shown.

Further, the numerical control device 20 outputs an instruction position for each block of the machining program and a position for each interpolation period, which are included in the operation instruction, to the selection device 10 described later as pieces of position data in association with time-series information.

When the machine tool not shown is a robot or the like, the numerical control device 20 may be a robot control device or the like.

### <Interference Check Device 30>

The interference check device 30 is, for example, a computer or the like. The interference check device 30 stores the contour shapes of a tool and a workpiece, the contour shape of a machine, and the like in advance, and checks whether interference will occur between the tool and other things such as the workpiece, based on positions of an observation-target movable part included in the machine tool not shown, which are sent from the selection device 10. The interference check device 30 transmits interference check processing completion information including time required for interference check processing, to the selection device 10. Further, the interference check device 30 may be adapted to output an axis stop signal to the numerical control device 20 when it is judged that interference will occur.

### <Selection Device 10>

The selection device 10 is, for example, a computer or the like. As described later, the selection device 10 preferentially selects, among pieces of position data received from the numerical control device 20, instruction positions which ensure the real-time property of physical simulation by the interference check device 30 and reduce errors between the physical simulation and the observation-target movable part (the control axis). The selection device 10 outputs the selected pieces of position data to the interference check device 30.

As shown in FIG. 1, the selection device 10 includes a holding unit 110 and a control unit 120. The control unit 120 includes a range determination unit 121, a number-of-pieces-of-data determination unit 122, and a selection unit 123.

The holding unit 110 is a RAM (random access memory) or the like, and holds pieces of position data associated with time-series information, which have been received from the numerical control device 20.

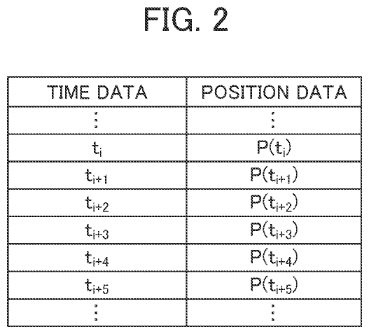

FIG. 2 is a diagram showing an example of the pieces of position data held by the holding unit 110.

As shown in FIG. 2, the holding unit 110 holds instruction positions and positions for interpolation periods (for example, P(tᵢ) and the like), which are received from the selection device 10, in association with time points (for example, tᵢ or the like) at which the instruction positions and the positions for the interpolation periods have been instructed (i is an integer equal to or larger than 1).

It is preferable that, when receiving an instruction position from the numerical control device 20, the holding unit 110 holds the instruction position in a state in which it can be judged to be an instruction position, for example, using a flag or the like.

The control unit 120 includes a CPU (central processing unit), a ROM (read-only memory), a RAM, a CMOS (complementary metal-oxide-semiconductor) memory, and the like, and these are configured to be mutually communicable via a bus and are well known to one skilled in the art.

The CPU is a processor that controls the whole selection device 10. The CPU reads out a system program and an application program that are stored in the ROM via the bus and controls the whole selection device 10 according to the system program and the application program. Thereby, the control unit 120 is configured to realize the functions of the range determination unit 121, the number-of-pieces-of-data determination unit 122, and the selection unit 123 as shown in FIG. 1. The CMOS memory is backed up by a battery not shown and is configured as a non-volatile memory the storage state of which is maintained even if the power source of the selection device 10 is turned off.

The range determination unit 121 determines, for example, an earliest time point Tₘᵢₙ(m) and a latest time point Tₘₐₓ(m) indicating a range for selecting pieces of position data for the m-th time from among the pieces of position data held by the holding unit 110 (m is an integer equal to or larger than 1). The range determination unit 121 causes pieces of position data satisfying the range condition of Tₘᵢₙ(m)≤tᵢ<Tₘₐₓ(m) to be candidate positions.

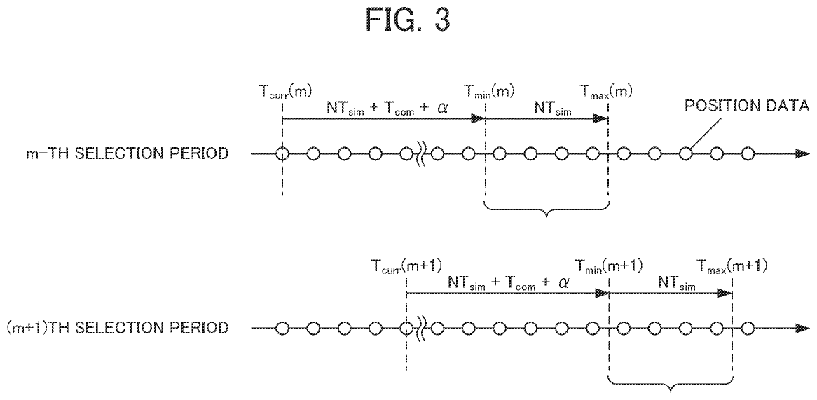

For example, as shown in FIG. 3, when, in a selection period for selecting pieces of position data for the m-th time at a timing of the number-of-pieces-of-data determination unit 122 described later receiving the interference check processing completion information from the interference check device 30, current time point measured based on a clock signal of a clock (not shown) included in the selection device 10 is indicated by T_{curr}(m), time required for the interference check device 30 to perform interference check processing (physical simulation) using N pieces of position data is indicated by N×Tₛᵢₘ, time required for communication between the selection device 10 and the interference check device 30 is indicated by T_{com}, time required to decelerate and stop the moving movable part is indicated by Tₛₜₒₚ, and predetermined spare time is indicated by α, the earliest time point Tₘᵢₙ(m) is required to satisfy the relationship of Formula (1).

Tₘᵢₙ(m)≥T_{curr}(m)+N×Tₛᵢₘ+T_{com}+Tₛₜₒₚ+α (1)

That is, the earliest time point Tₘᵢₙ(m) needs to be a lead time point sufficiently before the movable part stops in time after interference check by the interference check device 30. Here, Tₛᵢₘ indicates time required for interference check processing (physical simulation) per piece of position data, and N indicates an integer equal to or larger than 1.

The range determination unit 121 determines the earliest time point at which Formula (1) holds true (that is, in the case of the equal sign) as the earliest time point Tₘᵢₙ(m). At the time of the numerical control device 20 starting the machining program, the range determination unit 121 may determine the earliest time point Tₘᵢₙ(m) at a timing of accepting an instruction to start the machining program.

Further, in order to assign each of all the pieces of position data of the holding unit 110 to a candidate position in any selection period such that the pieces of position data just correspond to the candidate positions, respectively, the latest time point Tₘₐₓ(m) in the m-th selection period and the earliest time point Tₘᵢₙ(m+1) in the (m+1)th selection period are required to satisfy the condition of Formula (2) as shown in FIG. 3.

Tₘₐₓ(m)=Tₘᵢₙ(m+1)=Tₘᵢₙ(m)+N×Tₛᵢₘ (2)

The range determination unit 121 calculates the latest time point Tₘₐₓ(m) based on Formula (2). The range determination unit 121 notifies the selection unit 123 described later of the candidate positions of the pieces of position data in the range of the earliest time point Tₘᵢₙ(m)≤ tᵢ<the latest time point Tₘₐₓ(m) among the pieces of position data held by the holding unit 110.

Here, the time T_{com} required for communication between the selection device 10 and the interference check device 30 is a constant value that does not fluctuate almost at all after the configuration of the interference check system 1 of FIG. 1 is determined, and is a value that can be determined by measurement in advance. The time Tₛₜₒₚ required for deceleration and stop is a constant value determined according to the configuration of the numerical control device 20. On the other hand, the time N×Tₛᵢₘ that the interference check device 30 requires for interference check processing differs according to a position of the movable part. Especially, in the case of controlling axes belonging to different systems or machines to cause the axes to work in common work space, there are a plurality of movable parts, and, therefore, the time N×Tₛᵢₘ required for interference check differs according to operation positions of the plurality of movable parts.

Therefore, the interference check device 30 may include time required for executed interference check into the interference check processing completion information and feed back the interference check processing completion information to the selection device 10, and the selection device 10 (the range determination unit 121) may set the time included in the interference check processing completion information as the time N×Tₛᵢₘ required for interference check. That is, a position of the movable part for which interference check has been executed last and a position of the movable part for which interference check is to be performed next are near to each other, and time required for performing interference check next is estimated to be equal. Therefore, time required for the interference check executed immediately before is set to the time N×Tₛᵢₘ required for the interference check this time. Or alternatively, the range determination unit 121 may calculate an average of values corresponding to the latest several number of times in the past as the time N×Tₛᵢₘ required for interference check.

The number-of-pieces-of-data determination unit 122 sets the number N of pieces of position data to be selected from among the pieces of position data existing in the range determined by the range determination unit 121, in consideration of a processing load of physical simulation of the interference check device 30.

Specifically, the number-of-pieces-of-data determination unit 122 monitors the state of the interference check device 30 in automatic operation, for example, with reference to the interference check processing completion information received from the interference check device 30, and sets the number N of pieces of position data to be selected by the selection unit 123 described later when the interference check processing is completed. Then, the number-of-pieces-of-data determination unit 122 outputs an instruction to the selection unit 123 described later to select the set number N of pieces of position data.

The number-of-pieces-of-data determination unit 122 may set the number N by a user in advance via an input device (not shown) such as a keyboard and a touch panel included in the selection device 10.

Thereby, by the selection device 10 selecting N pieces of position data each time interference check processing (physical simulation) by the interference check device 30 is completed, the selection device 10, it is possible to avoid the interference check processing (the physical simulation) by the interference check device 30 being delayed due to a pileup state.

Among the pieces of position data (candidate positions) existing in the range determined by the range determination unit 121, the selection unit 123 selects the set number N of pieces of position data that reduce errors between the physical simulation and the observation-target movable part.

Hereinafter, description will be made on operation of the selection unit 123 in (A) a case where the number N is set to “1”, and one instruction position exists in the range determined by the range determination unit 121 and (B) a case where the number N is set to “2”, and four instruction positions exist in the range determined by the range determination unit 121.

(A) about the Case where the Number N is Set to “1”, and One Instruction Position Exists in the Range Determined by the Range Determination Unit 121

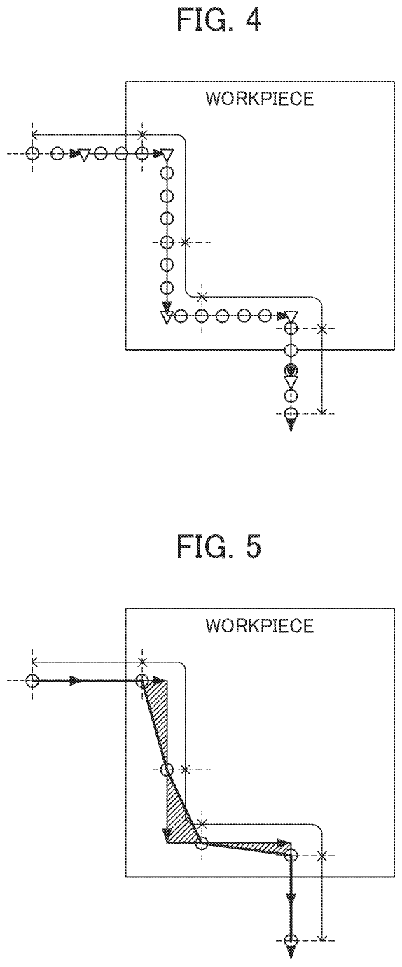

FIG. 4 is a diagram showing an example of a tool path. In FIG. 4, an instruction position for each block of the machining program is indicated by a triangle, and a position for each interpolation period is indicated by a circle. In FIG. 4, a broken-line arrow indicates rapid feed, and a solid-line arrow indicates cutting feed. In FIG. 4, each section separated by broken lines is a selection period (candidate positions) indicated by the earliest time point Tₘᵢₙ(m) and the latest time point Tₘₐₓ(m) determined by the range determination unit 121, and time Tₛᵢₘ required for interference check processing (physical simulation) for one piece of position data by the interference check device 30.

In this case, since one instruction position (triangle) exists in each selection period determined by the range determination unit 121, the selection unit 123 selects one instruction position, which is the number of instruction positions set by the number-of-pieces-of-data determination unit 122. The selection unit 123 outputs the selected instruction position to the interference check device 30.

Though, when one instruction position exists in the determined range, the selection unit 123 selects the one instruction position corresponding to the set number N=1, the present invention is not limited thereto. For example, when the number N (≠1) is set, and N or fewer instruction positions exist among candidate positions determined by the range determination unit 121, the selection unit 123 may select the instruction positions. Then, when the number of selected instruction positions is smaller than N, the selection unit 123 may select pieces of position data so that the total is N, in order starting from a piece of position data nearest to the latest time point Tₘₐₓ(m).

Thereby, an instruction position indicating switching between rapid feed and cutting feed is outputted from the selection device 10, and the interference check device 30 can execute interference check processing (physical simulation) for each of rapid feed sections and cutting feed sections. By the selection device 10 outputting instruction positions, it is possible to reduce errors between physical simulation and an actual tool path, improve the accuracy of the physical simulation, and also improve the accuracy of interference check.

Next, comparison with Patent Document 1 as a conventional technology will be performed.

FIG. 5 is a diagram showing an example of positions on the tool path of FIG. 4, which are outputted to the interference check device 30 by the conventional technology.

As shown in FIG. 5, in Patent Document 1, a position at a time point corresponding to the time Tₛᵢₘ required for interference check processing (physical simulation) by the interference check device 30 (that is, the earliest time point Tₘᵢₙ(m) or the latest time point Tₘₐₓ(m)) is outputted to the interference check device 30. Therefore, in Patent Document 1, switching between a rapid feed section (the broken-line arrow) and a cutting feed section (the solid-line arrow) is unclear, and it is difficult to execute interference check processing (physical simulation) for each of the rapid feed sections and the cutting feed sections.

Further, in Patent Document 1, since errors (areas indicated by hatching in FIG. 5) between a path of interference check processing (physical simulation) indicated by a thick solid line and an actual tool path are large in comparison with the case of FIG. 4, there may be a case where problems of false detection of interference, not preventing interference, and the like occur because the accuracy of simulation is not sufficient.

(B) About the Case where the Number N is Set to “2”, and Four Instruction Positions Exist in the Range Determined by the Range Determination Unit 121

Though description will be made on the case where the number N is set to “2”, and four instruction positions exist in the range determined by the range determination unit 121, the same goes for a case where the number is set to N, and more than N instruction positions exist in the range determined by the range determination unit 121, and description thereof will be omitted.

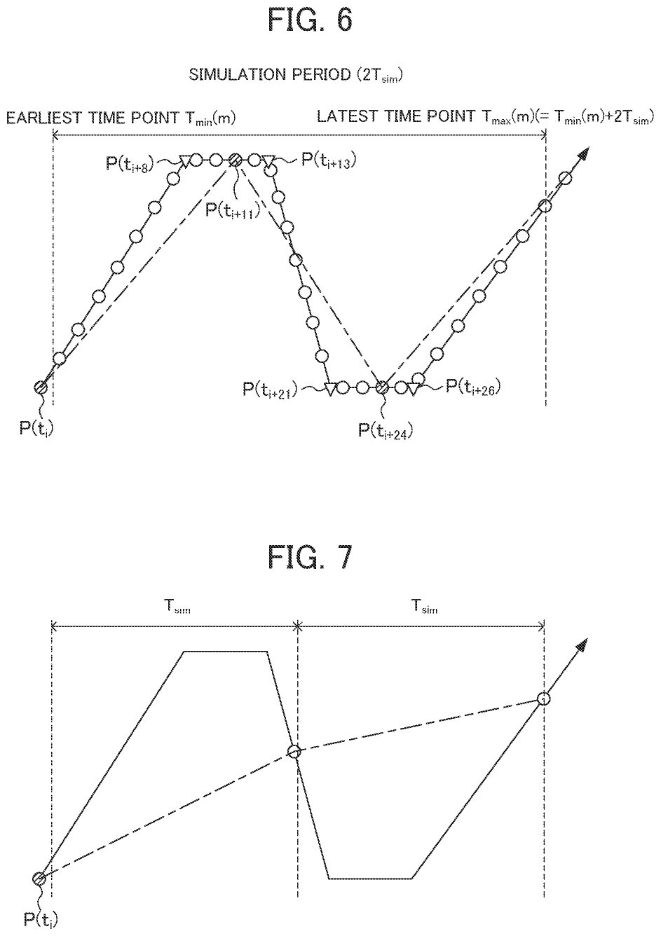

FIG. 6 is a diagram showing an example of the tool path. In FIG. 6, the tool moves from left to right on the tool path. Further, in FIG. 6, similarly to the case of FIG. 4, an instruction position for each block of the machining program is indicated by a triangle, and a position for each interpolation period is indicated by a circle. In FIG. 6, similarly to the case of FIG. 4, each section separated by broken lines is a selection period (candidate positions) indicated by the earliest time point Tₘᵢₙ(m) and the latest time point Tₘₐₓ(m) determined by the range determination unit 121, and time 2Tₛᵢₘ required for interference check processing (physical simulation) by the interference check device 30 using two pieces of position data.

The selection unit 123 extracts four instruction positions P(tᵢ₊₈), P(tᵢ₊₁₃), P(tᵢ₊₂₁), and P(tᵢ₊₂₆) in the m-th selection period (among candidate positions) and calculates each distance between adjacent instruction positions. The selection unit 123 selects a combination of instruction positions the distance between which is the shortest, for example, P(tᵢ₊₂₁) and P(tᵢ₊₂₆). The selection unit 123 calculates a position of the middle point between the selected instruction positions P(tᵢ₊₂₁) and P(tᵢ₊₂₆), and causes a piece of position data nearest to the calculated position of the middle point, for example, a position P(tᵢ₊₂₄) indicated by a hatched circle to be a new instruction position.

Next, the selection unit 123 calculates each distance between adjacent instruction positions among the three instruction positions P(tᵢ₊₈), P(tᵢ₊₁₃), and P(tᵢ₊₂₄). The selection unit 123 selects a combination of the instruction positions P(tᵢ₊₈) and P(tᵢ₊₁₃) the distance between which is the shortest. The selection unit 123 calculates a position of the middle point between the selected instruction positions P(tᵢ₊₈) and P(tᵢ₊₁₃), and causes a piece of position data nearest to the calculated position of the middle point, for example, a position P(tᵢ₊₁₁) indicated by a hatched circle to be a new instruction position.

Then, since the two instruction positions P(tᵢ₊₁₁) and P(tᵢ₊₂₄) are obtained, the selection unit 123 outputs the two instruction positions P(tᵢ₊₁₁) and P(tᵢ₊₂₄) to the interference check device 30. A long dashed short dashed line indicates a path of interference check processing (physical simulation) executed by the interference check device 30, which is obtained by piecewise linear approximation.

Thereby, the selection device 10 can select a path (positions) obtained by piecewise linear approximation of the path constituted by the candidate positions determined by the range determination unit 121 with N line segments. Further, since the number of instruction positions is necessarily reduced to two within a selection period, the real-time property of physical simulation is ensured.

Next, Patent Document 1 and Patent Document 2 will be compared as conventional technologies.

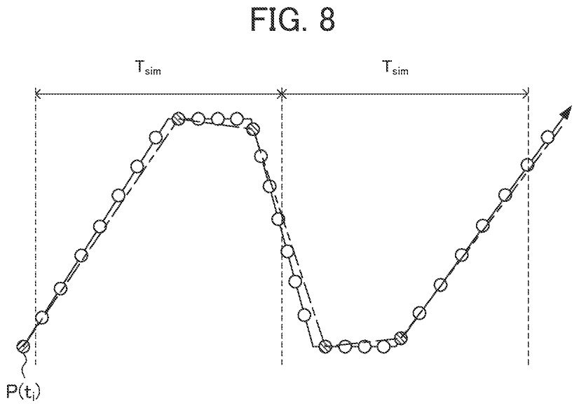

FIGS. 7 and 8 are diagrams showing examples of positions outputted to the interference check device 30 on the tool path of FIG. 6 by the conventional technologies.

As shown in FIG. 7, in Patent Document 1, a position for time required for each simulation per piece of position data by the interference check device 30 is outputted to the interference check device 30. Therefore, in Patent Document 1, since errors between the path indicated by a long dashed short dashed line and an actual tool path are large in comparison with the case of FIG. 6, it is difficult to perform simulation in consideration of the path errors.

Further, as shown in FIG. 8, though positions indicated by hatched circles are selected in Patent Document 2, it is difficult to thin out position data for time required for each simulation per piece of position data by the interference check device 30, and it is difficult to ensure the real-time property of simulation.

Though the selection unit 123 selects two pieces of position data from among candidate positions including four instruction positions, it is preferable that the number N is set according to distribution of instruction positions.

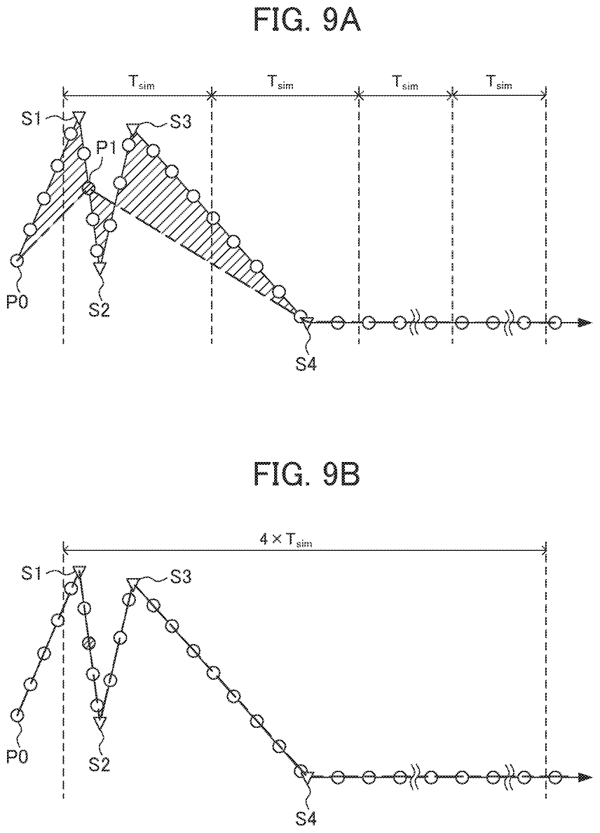

FIG. 9A is a diagram showing an example of the case where the number N is set to “1”. FIG. 9B is a diagram showing an example of a case where the number N is set to “4”. In FIGS. 9A and 9B, a position P0 indicates a piece of position data selected in the last selection period, and positions S1 to S4 indicate instruction positions after the selection period.

As shown in FIG. 9A, when the number N is set to “1”, the time required for interference check processing (physical simulation) by the interference check device 30 using one piece of position data is the time Tₛᵢₘ. Therefore, in the selection period in which the instruction positions S1 to S3 exist, the selection unit 123 selects the position P1 as the instruction position in the selection period by piecewise linear approximation. Then, the selection unit 123 outputs the selected position P1 to the interference check device 30. In the next selection period, since only the instruction position S4 exists, the selection unit 123 selects the instruction position S4 and outputs it to the interference check device 30.

In this case, the interference check device 30 performs interference check processing (physical simulation) along a path indicated by a long dashed short dashed line connecting the positions P0 and P1, the instruction position S4, and the like. Therefore, in the selection period in which the instruction positions S1 to S3 exist, errors between the path indicated by the long dashed short dashed line and an actual tool path (areas indicated by hatching) are large.

On the other hand, as shown in FIG. 9B, when the number N is set to “4”, time required for interference check processing (physical simulation) by the interference check device 30 using four pieces of position data is time 4×Tₛᵢₘ. Therefore, the selection unit 123 can select all the instruction positions S1 to S4.

Therefore, the interference check device 30 can perform interference check processing (physical simulation) along a path indicated by a long dashed short dashed line connecting the instruction positions S1 to S4 and the like, and it is possible to reduce errors between the path indicated by a long dashed short dashed line and the actual tool path.

That is, as shown in FIGS. 9A and 9B, as the number N is set to a larger value, positions can be selected more freely, and the path accuracy tends to be higher. On the other hand, as the number N is set larger, the difference between T_{curr}(m) and Tₘᵢₙ(m) is larger as shown by Formula (1), and the real-time property is lost. Therefore, since the path accuracy and the real-time property are traded off against each other, it is preferable to individually set the number N according to interference check processing (physical simulation) to be performed.

### <Selection Process of Selection Device 10>

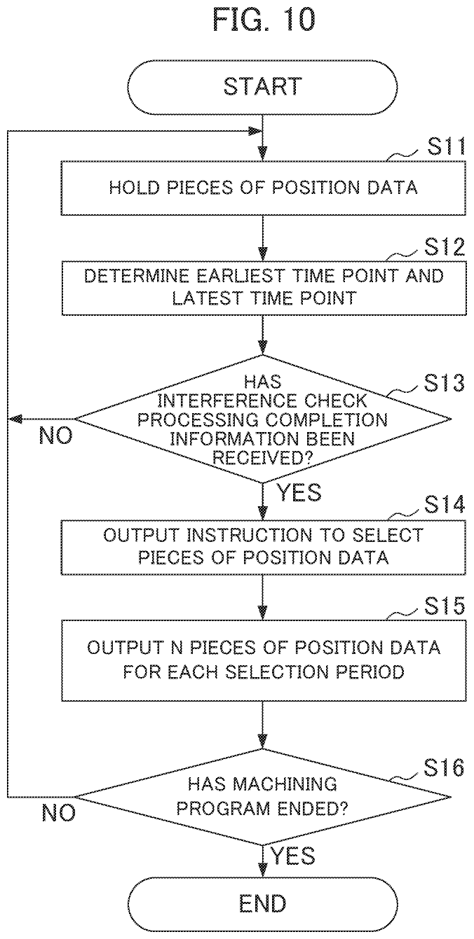

Next, a flow of a selection process of the selection device 10 will be described with reference to FIG. 10.

FIG. 10 is a flowchart illustrating the selection process of the selection device 10. The flow shown here is repeatedly executed each time the numerical control device 20 executes the machining program.

At Step S11, the holding unit 110 holds instruction positions and positions for each interpolation period associated with time-series information, which have been received from the numerical control device 20 by the numerical control device 20 executing the machining program, as pieces of position data.

At Step S12, the range determination unit 121 determines the earliest time point Tₘᵢₙ(m) and the latest time point Tₘₐₓ(m) indicating a range for selecting pieces of position data for the pieces of position data held by the holding unit 110 based on the current time point T_{curr} (m), Formulas (1) and (2), in the m-th selection period.

At Step S13, the number-of-pieces-of-data determination unit 122 judges whether interference check processing completion information has been received or not. If the interference check processing completion information has been received, the process proceeds to Step S14. On the other hand, if the interference check processing completion information has not been received, the process returns to Step S11. In the case of the numerical control device 20 having just executed the processing program, the processing of Step S13 may be omitted because the interference check device 30 has not executed interference check processing (physical simulation) yet.

At Step S14, the number-of-pieces-of-data determination unit 122 outputs an instruction to select the set number N of pieces of position data, to the selection unit 123.

At Step S15, the selection unit 123 selects N pieces of position data for each selection period. The selection unit 123 outputs the selected N pieces of position data to the interference check device 30.

At Step S16, the selection unit 123 judges whether execution of the machining program has ended or not. If execution of the machining program has ended, the selection device 10 ends the selection process. On the other hand, if execution of the machining program has not ended, the process returns to Step S11.

As described above, the selection device 10 according to the one embodiment calculates the earliest time point Tₘᵢₙ(m), which is lead time point sufficiently before the movable part stops in time after interference check by the interference check device 30, and the latest time point Tₘₐₓ(m) obtained by adding the time N×Tₛᵢₘ required for interference check processing (physical simulation) by the interference check device 30 using N pieces of position data to the earliest time point Tₘᵢₙ(m), based on the current time point T_{curr}(m) in the m-th selection period; selects N pieces of position data for each selection period determined by the earliest time point Tₘᵢₙ(m) and latest time point Tₘₐₓ(m); and outputs the selected N pieces of position data to the interference check device 30.

Thereby, the selection device 10 can reduce pieces of position data to a quantity which can be processed in interference check processing (physical simulation) to thereby stabilize processing time of the physical simulation and prevent loss of a real-time property.

Further, the selection device 10 can select such pieces of position data that errors between an observation-target movable part (a control axis) and interference check processing (physical simulation) are reduced, while ensuring the real-time property.

One embodiment has been described above. The selection device 10, however, is not limited to the above embodiment, and modifications, improvements, and the like are included within a range in which the object can be achieved.

### Modification Examples

Though the selection device 10 is assumed to be an device different from the numerical control device 20 and the interference check device 30 in the one embodiment, the present invention is not limited thereto. For example, the selection device 10 may be included in the interference check device 30.

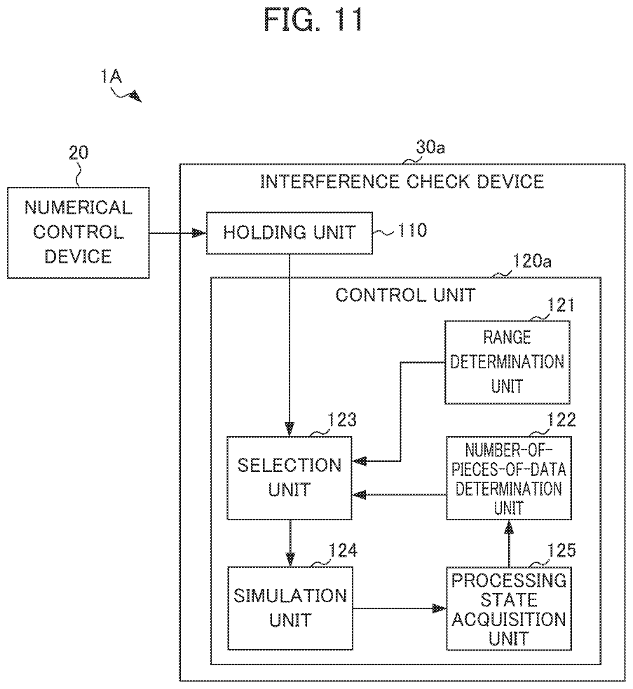

FIG. 11 is a functional block diagram showing a functional configuration example of an interference check system. Components having functions similar to those of components of the selection device 10 in FIG. 1 will be given the same reference numerals, and detailed description thereof will be omitted.

As shown in FIG. 11, an interference check system 1A includes a numerical control device 20 and an interference check device 30a as a simulation device.

The numerical control device 20 and the interference check device 30a may be mutually directly connected via connection interfaces not shown. Further, the numerical control device 20 and the interference check device 30a may be mutually connected via a network not shown, such as a LAN or the Internet.

The interference check device 30a includes a holding unit 110 and a control unit 120a. The control unit 120a includes a range determination unit 121, a number-of-pieces-of-data determination unit 122, a selection unit 123, a simulation unit 124, and a processing state acquisition unit 125.

The holding unit 110, the range determination unit 121, the number-of-pieces-of-data determination unit 122, and the selection unit 123 have functions equivalent to those of the holding unit 110, the range determination unit 121, the number-of-pieces-of-data determination unit 122, and the selection unit 123 of the one embodiment. The holding unit 110, the range determination unit 121, the number-of-pieces-of-data determination unit 122, and the selection unit 123 function as the selection device 10 by working together.

The simulation unit 124 performs interference check processing (physical simulation) using pieces of position data selected by the selection unit 123. The simulation unit 124 outputs information including any of a load of the simulation unit 124 and a completion status of interference check processing (physical simulation) by the simulation unit 124, to the processing state acquisition unit 125 described later.

The processing state acquisition unit 125 acquires the information including any of the load of the simulation unit 124 and the completion status of interference check processing (physical simulation) from the simulation unit 124. The processing state acquisition unit 125 outputs the acquired information to the number-of-pieces-of-data determination unit 122 as an interference check processing completion state.

The selection device 10 may be included in a communication control device that relays communication between the numerical control device 20 and the interference check device 30.

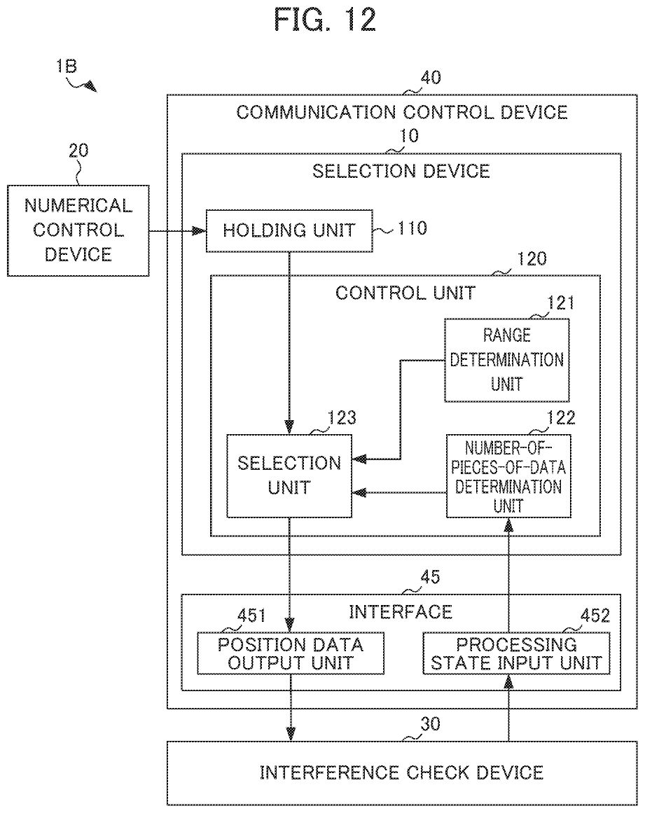

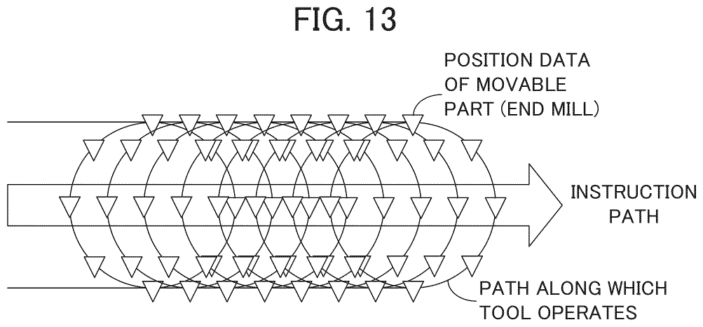

FIG. 12 is a functional block diagram showing a functional configuration example of an interference check system. Components having functions similar to those of components of the selection device 10 in FIG. 1 will be given the same reference numerals, and detailed description thereof will be omitted.

As shown in FIG. 12, an interference check system 1B includes a numerical control device 20, a communication control device 40, and an interference check device 30 as a simulation device.

The numerical control device 20, the communication control device 40, and the interference check device 30 may be mutually directly connected via connection interfaces not shown. Further, the numerical control device 20, the communication control device 40, and the interference check device 30 may be mutually connected via a network not shown, such as a LAN or the Internet.

The communication control device 40 includes a selection device 10 and an interface 45. Further, the selection device 10 includes a holding unit 110 and a control unit 120. The control unit 120 includes a range determination unit 121, a number-of-pieces-of-data determination unit 122, and a selection unit 123. Further, the interface 45 includes a position data output unit 451 and a processing state input unit 452.

The holding unit 110, the range determination unit 121, the number-of-pieces-of-data determination unit 122, and the selection unit 123 have functions equivalent to those of the holding unit 110, the range determination unit 121, the number-of-pieces-of-data determination unit 122, and the selection unit 123 of the one embodiment.

The interface 45 controls communication between the communication control device 40 and the interference check device 30.

The position data output unit 451 transfers pieces of position data selected by the selection device 10 (the selection unit 123) to the interference check device 30.

The processing state input unit 452 receives input of information including at least any of a load of hardware of the interference check device 30, a completion status of interference check processing (physical simulation) at a predetermined time point (for example, the earliest time point Tₘᵢₙ(m), the latest time point Tₘₐₓ(m), or the like), and an instruction to output pieces of position data from the interference check device 30 from the interference check device 30. The processing state input unit 452 outputs the acquired information to the selection device 10 (the number-of-pieces-of-data determination unit 122) as interference check processing completion information.

Each of the functions included in the selection device 10 according to the one embodiment can be realized by hardware, software, or a combination thereof. Here, being realized by software means being realized by a computer reading and executing a program.

The program is stored in any of various types of non-transitory computer-readable media, and can be supplied to the computer. The non-transitory computer-readable media include various types of tangible storage media. Examples of the non-transitory computer-readable media include magnetic recording media (for example, a flexible disk, a magnetic tape, and a hard disk drive), magneto-optical recording media (for example, a magneto-optical disk), a CD-ROM (read-only memory), a CD-R, a CD-R/W, and a semiconductor memory (for example, a mask ROM, a PROM (programmable ROM), an EPROM (erasable PROM), a flash ROM, or a RAM). The program may be supplied to the computer by any of various types of transitory computer-readable media. Examples of the transitory computer-readable media include an electrical signal, an optical signal, and an electromagnetic wave. The transitory computer-readable media can supply the program to the computer via a wired communication path such as an electrical wire or an optical fiber, or a wireless communication path.

Steps describing the program recorded in a recording medium include not only processes that are performed in time series in the order thereof but also processes that are not necessarily performed in time series but are executed in parallel or individually.

In other words, a selection device, a simulation device, and a communication control device of the present disclosure can take various kinds of embodiments having the following configurations.

(1) A selection device 10 of the present disclosure is a selection device for, when physical simulation is performed with a movable part included in an industrial machine as an observation target, selecting pieces of position data showing a path of the movable part, the selection device including: a holding unit 110 configured to hold the pieces of position data in association with time-series information; a range determination unit 121 configured to determine an earliest time point and a latest time point indicating a range for selecting the pieces of position data from among the pieces of position data held by the holding unit 110; a number-of-pieces-of-data determination unit 122 configured to set a number of pieces of position data to be selected from among the pieces of position data existing in the range in consideration of a processing load of the physical simulation; and a selection unit 123 configured to select the set number of pieces of position data from among the pieces of position data existing in the range.

According to the selection device 10, it is possible to reduce pieces of position data to a quantity which can be processed in physical simulation, to thereby stabilize processing time of the physical simulation and prevent loss of a real-time property.

(2) In the selection device 10 described in (1), the pieces of position data may include instruction positions for instructions to the movable part.

Thereby, the selection device 10 can select pieces of position data that reduce errors between the track of interference check processing (physical simulation) and an actual track.

(3) In the selection device 10 described in (1) or (2), if the number of instruction positions set by the number-of-pieces-of-data determination unit 122 or fewer instruction positions exist in the range determined by the range determination unit 121, the selection unit 123 may preferentially select the instruction positions.

Thereby, it is possible to, by the selection device 10 preferentially selecting the instruction positions, reduce the errors between the path of interference check processing (physical simulation) and the actual path.

(4) In the selection device 10 described in any of (1) to (3), the selection unit 123 may perform piecewise linear approximation of a path with the set number of pieces of position data and select pieces of position data obtained by the approximation.

Thereby, the selection device 10 can select optimal pieces of position data for each selection period.

(5) An interference check device 30a of the present disclosure is a simulation device for executing the physical simulation of an observation target, the simulation device including: the selection device 10 of any of (1) to (4); a simulation unit 124 configured to perform the physical simulation using pieces of position data selected by the selection device 10; and a processing state acquisition unit 125 configured to acquire information including any of a load of the simulation unit 124 and a completion status of the physical simulation by the simulation unit 124.

According to the interference check device 30a, advantageous effects similar to those of (1) can be obtained.

(6) A communication control device 40 of the present disclosure is a communication control device communicably connected to the interference check device 30 performing the physical simulation of an observation target, the communication control device 40 including: the selection device 10 of any of (1) to (4); a position data output unit 451 configured to transfer pieces of position data selected by the selection device 10 to the interference check device 30; and a processing state input unit 452 configured to receive input of information from the interference check device 30, the information including at least any of a load of hardware of the interference check device 30, a completion status of the physical simulation at predetermined time point, and an instruction to output the pieces of position data from the interference check device 30.

According to the communication control device 40, advantageous effects similar to those of (1) can be obtained.

### EXPLANATION OF REFERENCE NUMERALS

1, 1A, 1B interference check system
10 selection device
110 holding unit
120, 120a control unit
121 range determination unit
122 number-of-pieces-of-data determination unit
123 selection unit
124 simulation unit
125 processing state acquisition unit
20 numerical control device
30, 30a interference check device
40 communication control device
45 interface
451 position data output unit
452 processing state input unit

1. A selection device for, when physical simulation is performed with a movable part included in an industrial machine as an observation target, selecting pieces of position data showing a path of the movable part, the selection device comprising:
a holding unit configured to hold the pieces of position data in association with time-series information;
a range determination unit configured to determine an earliest time point and a latest time point indicating a range for selecting the pieces of position data from among the pieces of position data held by the holding unit;
a number-of-pieces-of-data determination unit configured to set a number of pieces of position data to be selected from among the pieces of position data existing in the range in consideration of a processing load of the physical simulation; and
a selection unit configured to select the set number of pieces of position data from among the pieces of position data existing in the range.

2. The selection device according to claim 1, wherein the pieces of position data include instruction positions for instructions to the movable part.

3. The selection device according to claim 1, wherein if the number of instruction positions set by the number-of-pieces-of-data determination unit or fewer instruction positions exist in the range determined by the range determination unit, the selection unit preferentially selects the instruction positions.

4. The selection device according to claim 1, wherein the selection unit performs piecewise linear approximation of a path with the set number of pieces of position data and selects pieces of position data obtained by the approximation.

5. A simulation device for executing the physical simulation of an observation target, the simulation device comprising:
the selection device according to claim 1;
a simulation unit configured to perform the physical simulation using pieces of position data selected by the selection device; and
a processing state acquisition unit configured to acquire information including any of a load of the simulation unit and a completion status of the physical simulation by the simulation unit.

6. A communication control device communicably connected to the simulation device performing the physical simulation of an observation target, the communication control device comprising:
the selection device according to claim 1;
a position data output unit configured to transfer pieces of position data selected by the selection device to the simulation device; and
a processing state input unit configured to receive input of information from the simulation device, the information including at least any of a load of hardware of the simulation device, a completion status of the physical simulation at a predetermined time point, and an instruction to output the pieces of position data from the simulation device.
